(19) United States
(12) Patent Application Publication
(10) Pub. No.: US 2016/0155265 A1
(43) Pub. Date: Jun. 2, 2016

(54) ELECTRONIC DEVICE AND POINT CLOUD SAMPLING METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); ZHE-RUI WEI, Shenzhen (CN); PENG XIE, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/796,420

(22) Filed: Jul. 10, 2015

(30) Foreign Application Priority Data
Nov. 28, 2014 (CN) 201410710164.3

(51) Int. Cl. G06T 17/20; G06T 7/00

(52) U.S. Cl. CPC G06T 17/20; G06T 7/0079; G06T 2207/10028; G06T 2210/56

(57) ABSTRACT

An electronic device having a processing unit and storage device receives point cloud data, and divides a bounding box of the point cloud data into a plurality of segmented boxes. Then, the processing unit selects a plurality of data boxes each having at least one point from the segmented boxes and assigns a reference value to each such point in the data boxes. The processing unit selects initial sampling points from the points in the data boxes, based on the reference values, to form a sample point cloud and adds to or subtracts from the sample point cloud based on the number of initial sampling points and a predetermined sampling rate.

### CROSS-REFERENCE TO RELATED APPLICATIONS

This application claims priority to Chinese Patent Application No. 201410710164.3 filed on Nov. 28, 2014 in the China Intellectual Property Office, the contents of which are incorporated by reference herein.

### FIELD

The subject matter herein generally relates to point cloud processing.

### BACKGROUND

After an object is measured to form a point cloud, the amount of data in the point cloud is large. A sampling process relative to this large mass of data is an important procedure in the point cloud technology.

### BRIEF DESCRIPTION OF THE DRAWINGS

Implementations of the present technology will now be described, by way of example only, with reference to the attached figures, wherein:

FIG. 1 is a block diagram of one embodiment of an electronic device including a sampling system.

FIG. 2 is a block diagram of one embodiment of function modules of the sampling system in the electronic device of FIG. 1.

FIG. 3 illustrates a flowchart of one embodiment of a sampling method for the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

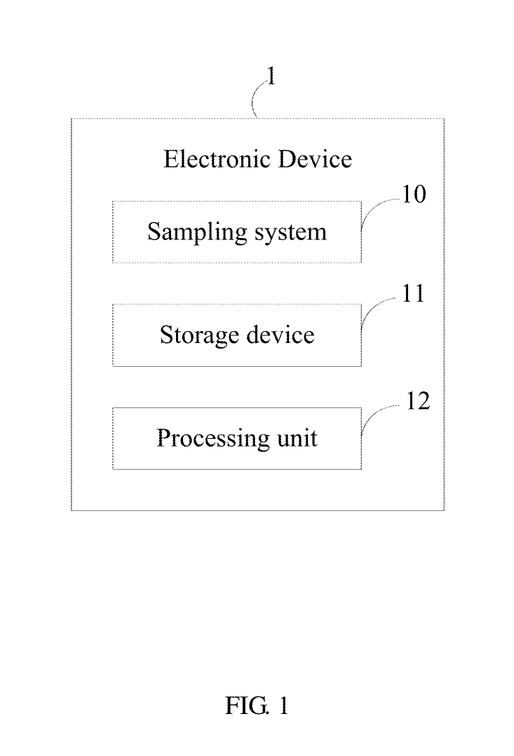

FIG. 1 illustrates an embodiment of an electronic device 1 including a sampling system 10. In the embodiment, the electronic device 1 can include a storage device 11 and a processing unit 12. The storage device 11 can store a plurality of instructions. When the plurality of instructions are executed by the processing unit 12, the processing unit 12 receives point cloud data, generates a bounding box for the point cloud data, divides the bounding box into a plurality of segmented boxes, selects a plurality of data boxes having data of at least one point in the point cloud data from the plurality of segmented boxes, assigns a reference value to each point in the plurality of data boxes, selects at least one initial sampling point from the at least one point in the plurality of data boxes based on the reference values to form a sample point cloud, and adjusts the size of the sample point cloud by increasing or decreasing the number of sampling points, based on the number of initial sampling points and a predetermined sampling rate. In this application, the term “point” may refer to a particular spatial location or may refer to computer data representing a particular spatial location.

The processing unit 12 can estimate three maximum distances of each axis direction for the point cloud data, and generate the bounding box based on the three maximum distances. The processing unit 12 can divide the bounding box according to a predetermined edge length L into a plurality of cubes and determine the cubes as each being a segmented box. The processing unit 12 determines which segmented boxes include at least one point in the point data cloud, and determines the segmented boxes which have at least one point as the data boxes.

The processing unit 12 can assign a reference value and a status value to each point in the data boxes. The reference values can be randomly generated and assigned by the processing unit 12. The status conferred by the processing unit 12 can be used to show which point is selected in the subsequent sampling procedure. The status value can be represented by a numeral, a letter, and a word.

The processing unit 12 can generate a box target number nₓ for each of the data boxes based on a predetermined sampling rate. The predetermined sampling rate can be less than one. In addition, the processing unit 12 can sort the at least one point in each of the data boxes based on the reference values of the points to form a sorting list for each of the data boxes. The processing unit 12 compares the number of points in each of the data boxes with each of the box target numbers. When the number of points in one of the data boxes is equal to or less than the box target number, the processing unit 12 selects and determines the at least one point in the data box as at least one initial sampling point. When the number of points in the data box is greater than the box target number, the processing unit 12 selects sequentially the initial sampling points from the sorting list.

The processing unit 12 determines a cloud target number nₜₒₜₐₗ for the point cloud data based on the predetermined sampling rate and the number of points in the point cloud data. The processing unit 12 compares the number of initial sampling points in the point cloud data with the cloud target number nₜₒₜₐₗ. When the number of initial sampling points in the point cloud data is equal to the cloud target number nₜₒₜₐₗ, the processing unit 12 determines the sample point cloud as achieving a final result. When the number of sampling points in the point cloud data is not equal to the cloud target number nₜₒₜₐₗ, the processing unit 12 can adjust the size of the sample point cloud. When the number of initial sampling points in the point cloud data is greater than the cloud target number nₜₒₜₐₗ, the processing unit 12 removes a number of initial sampling points from the sample point cloud. When the number of initial sampling points in the point cloud data is less than the cloud target number nₜₒₜₐₗ, the processing unit 12 can select additional sampling points from the points in the plurality of data boxes and add the additional sampling points into the sample point cloud.

The storage device 11 can be a non-volatile computer readable storage medium that can be electrically erased and reprogrammed, such as read-only memory (ROM), random-access memory (RAM), erasable programmable ROM (EPROM), electrically EPROM (EEPROM), hard disk, solid state drive, or other forms of electronic, electromagnetic, or optical recording medium. In one embodiment, the storage device 11 can include interfaces that can access the aforementioned computer readable storage medium to enable the electronic device 1 to connect to and access such computer readable storage medium. In another embodiment, the storage device 11 can include network accessing device to enable the electronic device 1 to connect and access data stored in a remote server or a network-attached storage.

The processing unit 12 can be a processor, a central processing unit (CPU), a graphic processing unit (GPU), a system on chip (SoC), a field-programmable gate array (FPGA), or a controller for executing the program instruction in the storage device 11. The storage device 11 can be static RAM (SRAM), dynamic RAM (DRAM), EPROM, EEPROM, flash memory, or other type of computer memory. The processing unit 12 can further include an embedded system or an application-specific integrated circuit (ASIC) having embedded program instructions.

In one embodiment, the electronic device 1 can be a server, a desktop computer, a laptop computer, or other electronic devices. Moreover, FIG. 1 illustrates only one example of an electronic device 1, other examples can include more or fewer components than illustrated, or have a different configuration of the various components in other embodiments.

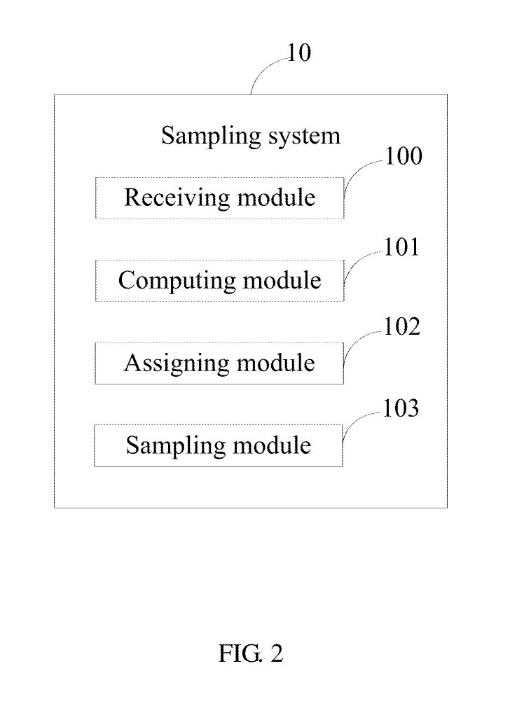

FIG. 2 illustrates an embodiment of function modules of the sampling system 10 in the electronic device 1 of FIG. 1. In at least one embodiment, the sampling system 10 can include one or more modules, for example, a receiving module 100, a computing module 101, an assigning module 102, and a sampling module 103. A “module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable medium include CDs, DVDs, BLU-RAY, flash memory, and hard disk drives.

The receiving module 100 can receive point cloud data. The computing module 101 generates a bounding box for the point cloud data, divides the bounding box into a plurality of segmented boxes, and selects boxes containing data as to points (data boxes) from the plurality of segmented boxes. Each of the data boxes includes at least one point in the point cloud data. Then, the assigning module 102 assigns a reference value to each of the at least one point in the plurality of data boxes. The sampling module 103 selects at least one initial sampling point from the at least one point in the plurality of data boxes, based on reference values, to form a sample point cloud, and adjusts the size of the sample point cloud based on the number of initial sampling points and a predetermined sampling rate.

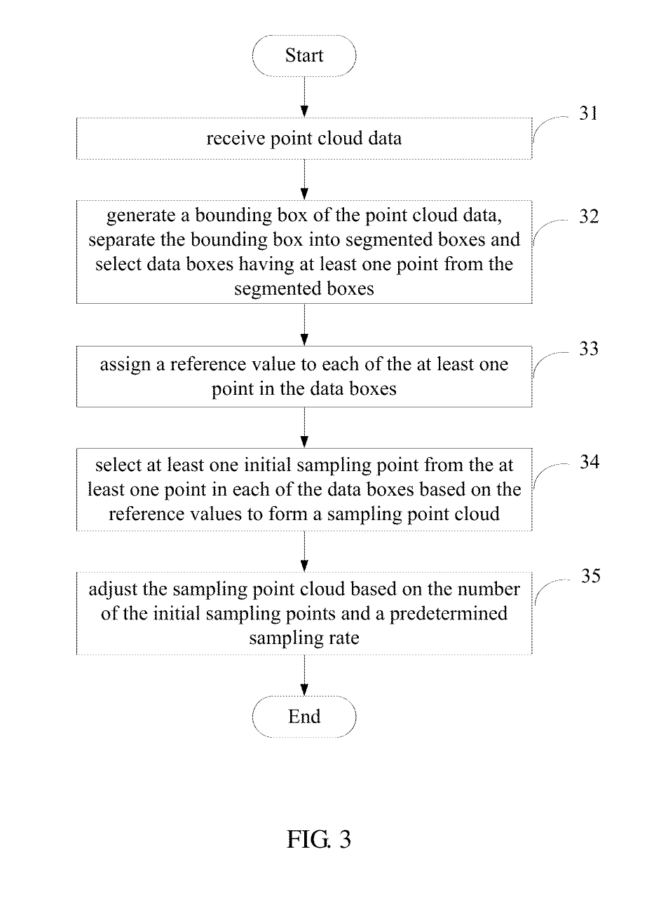

FIG. 3 illustrates a flowchart in accordance with an example embodiment. The example method is provided by way of example, as there are a variety of ways to carry out the method. The method described below can be carried out using the configuration illustrated in FIGS. 1 and 2, for example, and various elements of these figures are referenced in explaining example method. Each block shown in FIG. 3 represents one or more processes, methods, or subroutines, carried out in the example method. Furthermore, the order of blocks is illustrative only and can change. Additional blocks can be added or fewer blocks can be utilized without departing from this disclosure. The example method can begin at block 31.

At block 31, the receiving module 100 receives point cloud data having a plurality of points. In one embodiment, the point cloud data can be scanned by other devices and uploaded into the electronic device 1. In another embodiment, the electronic device 1 can directly scan an object to generate the point cloud data.

In one embodiment, the receiving module 100 can receive meshing information including the point cloud data. The meshing information can include a plurality of meshing triangles formed by point cloud data, a plurality of unit normal vectors for the meshing triangles, and three coordinates for each vertex of the meshing triangles.

At block 32, the computing module 101 generates a bounding box for the point cloud data, divides the bounding box into a plurality of segmented boxes, and selects a plurality of data boxes from the plurality of segmented boxes. In one embodiment, each of the data boxes includes at least one point in the point cloud data.

In one embodiment, the computing module 101 determines a minimum coordinate value and a maximum coordinate value of each axis direction for the point cloud data, and sets those values as pt1Min[x], pt1Min[y], pt1Min[z], pt1Max[x], pt1Max[y], and pt1Max[z]. The computing module 101 further determines a maximum distance value for each axis direction for the point cloud data, and sets those values as Δx, Δy, and Δz. The maximum distance for Δx is formed by subtracting pt1Mim[x] from pt1Max[x], the maximum distance for Δy is formed by subtracting pt1Mim[y] from pt1Max[y], and the maximum distance for Δz is formed by subtracting pt1Mim[z] from pt1Max[z]. Then, the computing module 101 generates the bounding box for the point cloud data by applying the maximum distances Δx, Δy, and Δz.

In one embodiment, the computing module 101 divides the bounding box into a plurality of segmented boxes. Each of the segmented boxes can be a cube having an edge length L. The number M of the segmented boxes in x-axis direction can be estimated by dividing the maximum distance Δx by the edge length L, the number N of the segmented boxes in y-axis direction can be estimated by dividing the maximum distance Δy by the edge length L, and the number W of the segmented boxes in z-axis direction can be estimated by dividing the maximum distance Δz by the edge length L.

In one embodiment, the computing module 101 can compute the average distance D_{avg} between the points in the point cloud data and determine the minimum value for the maximum distances Δx, Δy, and Δz. The computing module 101 can select the edge length L within a range between the average distance D_{avg} and the minimum value of the three maximum distances Δx, Δy, and Δz.

In one embodiment, the computing module 101 can set up a chain list list[M][N][W], and upload the information of the segmented boxes into the chain list. In the embodiment, the computing module 101 can fill box numbers of the segment boxes and point numbers of the points in the segment boxes into the chain list. The computing module 101 determines whether the segmented boxes include at least one point according to the chain list, and determines that the segmented boxes having at least one point are data boxes. If there is not at least one point in the segmented boxes, the computing module determines that such a segmented box is not a data box.

In one embodiment, the computing module 101 can set up a data chain list, and upload information of the data boxes into the data chain list. In the embodiment, the computing module 101 can write the box numbers of the data boxes and the point numbers of the points in the data boxes into the data chain list.

At block 33, the assigning module 102 assigns a reference value to each of the at least one point in the data boxes.

In one embodiment, the assigning module 102 can assign a reference value and a status value to each point in the data boxes. The reference values can be randomly generated and assigned by the assigning module 102. The status value can show which point among other points is selected in the subsequent sampling procedure. The status value can be represented by a numeral, a letter, and a word. For example, if a specific point is selected to be added into a sample result, the status value of that point can be changed from zero to one. If a specific point is not selected for adding into the sample result, the status of that point can remain zero.

At block 34, the sampling module 103 selects at least one initial sampling point from the points in the data boxes, based on the reference values, to form a sample point cloud.

In one embodiment, the sampling module 103 can generate a box target number nₓ for each of the data boxes based on a predetermined sampling rate. For example, the sampling module 103 can generate a first box target number n₁ for the first data box, based on the predetermined sampling rate and the number of points in the first data box. The predetermined sampling rate can be less than one.

In one embodiment, the sampling module 103 sorts the points in each of the data boxes, based on the reference values of the points in the point cloud data, to form a sorting list for each of the data boxes. In the embodiment, the points in the sorting list can be sorted from maximum to minimum or from minimum to maximum based on the reference values.

In one embodiment, the sampling module 103 compares the number of points in each of the data boxes with each of the box target numbers. For example, the sampling module 103 compares the number of points in the first data box with the first box target number n₁. When the number of points in the first data box is equal to or less than the first box target number n₁, the sampling module 103 selects all of the points in the first data box, and determines each of the points in the first data box as being an initial sampling point. Thus, the sampling module 103 can change the status value of all the points in the first box from zero to one. When the number of points in the first data box is greater than the first box target number n₁, the sampling module 103 sequentially selects n₁ initial sampling points from the sorting list, and changes the status of the n₁ points to 1. Thus, the sampling module 103 can obtain at least one initial sampling point in each of the data boxes to form the sample point cloud.

In one embodiment, when the box target number nₓ for each of the data boxes is a ceiling value generated by multiplying the number of points in each of the data boxes by the predetermined sampling rate, the box target number nₓ for each of the data boxes can be equal to or less than the number of points in each of the data boxes. For example, when the number of points in one of the data boxes is one, the box target number of the data box can also be one. Thus, the sampling module 103 can sequentially select n₁ initial sampling points from the sorting list of the first data box, or determine that all of the points in the first data box are initial sampling points.

At block 35, the sampling module 103 adjusts the content of the sample point cloud based on the number of initial sampling points and a predetermined sampling rate.

In one embodiment, the sampling module 103 determines a cloud target number nₜₒₜₐₗ for the point cloud data based on the predetermined sampling rate and the number of points in the point cloud data.

In one embodiment, the sampling module 103 compares the number of initial sampling points in the point cloud data with the cloud target number nₜₒₜₐₗ. When the number of initial sampling points in the point cloud data is equal to the cloud target number nₜₒₜₐₗ, the sampling module 103 determines that the sample point cloud so obtained is the final or end result. When the number of initial sampling points in the point cloud data is not equal to the cloud target number nₜₒₜₐₗ, the sampling module 103 can adjust the content of the sample point cloud.

In one embodiment, when the number of initial sampling points in the point cloud data is greater than the cloud target number nₜₒₜₐₗ, the sampling module 103 removes a number of initial sampling points from the sample point cloud. In one embodiment, the sampling module 103 calculates R number of initial sampling points which are redundant by subtracting the cloud target number nₜₒₜₐₗ from the number of initial sampling points. Then, the sampling module 103 can randomly remove R initial sampling points from the sampling point cloud.

In one embodiment, when the number of initial sampling points in the point cloud data is less than the cloud target number nₜₒₜₐₗ, the sampling module 103 can select additional sampling points from the points in the plurality of data boxes which were not initially selected for sampling and add the additional sampling points into the sample point cloud. In one embodiment, the sampling module 103 can compare the cloud target number nₜₒₜₐₗ and the number of initial sampling points and determine whether or not there is a differential value in view of the number of data boxes. When there is a differential value which is equal to or less than the number of the data boxes, the sampling module 103 can select at least one supplemental box from the data boxes. The number of the supplemental boxes selected is equal to the differential value. The sampling module 103 determines the first unselected point in each sorting list of the supplemental boxes as being an additional sampling point, adds the additional sampling point in the supplemental box into the sampling point cloud to achieve a sample result, and changes the status value of the additional sampling points to 1. When there is a differential value which is greater than the number of the data boxes, the sampling module 103 determines the first unselected point in each sorting list of the data boxes as an additional sampling point, adds the additional sampling point into the sampling point cloud, and compares the cloud target number nₜₒₜₐₗ and the number of initial sampling points again. After comparing the new differential value with the cloud target number and determining unselected point as the additional sampling point repeatedly, the sampling module 103 can obtain the sampling result.

In one embodiment, since the number of points in a portion of the data boxes can be less than their respective box target numbers, that portion of the data boxes can be temporarily extended to include other points which are selectable as additional sampling points. For example, the edge length L of a portion of the data boxes can be increased temporarily. After this portion of the data boxes is extended, the sampling module 103 can refresh the sorting lists for selecting additional sampling points.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including, the full extent established by the broad general meaning of the terms used in the claims.

What is claimed is:

1. An electronic device comprising:
a processing unit; and
a storage device that stores a plurality of instructions, when executed by the processing unit, causes the processing unit to:
receive point cloud data;
generate a bounding box for the point cloud data;
divide the bounding box into a plurality of segmented boxes;
select a plurality of data boxes from the plurality of segmented boxes, wherein each of the data boxes includes at least one point in the point cloud data;
assign a reference value to each of the at least one point in the data boxes;
select at least one initial sampling point from the at least one point in each of the data boxes based on the reference values to form a sampling point cloud; and
adjust the sampling point cloud based on the number of the initial sampling points and a predetermined sampling rate.

2. The electronic device according to claim 1, wherein the plurality of instructions further cause the processing unit to:
sort the at least one point in each of the data boxes based on the reference values to form a sorting list;
determine a box target number for each of the data boxes based on the predetermined sampling rate; and
select sequentially the initial sampling points from the sorting lists based on the box target numbers.

3. The electronic device according to claim 2, wherein each of the box target number is generated based on the predetermined sampling rate and the number of the points in each of the data boxes.

4. The electronic device according to claim 2, wherein the plurality of instructions further cause the processing unit to:
compare the number of at least one specific point in a specific data box, with a specific box target number of the specific data box;
determine the at least one specific point as the at least one initial sampling point when the number of the at least one specific point is equal to or less than the specific box target number; and
select sequentially the at least one initial sampling point based on the specific box target number when the number of the at least one specific point is greater than the specific box target number.

5. The electronic device according to claim 1, wherein the plurality of instructions further cause the processing unit to:
determine a cloud target number for the point cloud data based on the predetermined sampling rate; and
compare the number of the initial sampling points with the cloud target number.

6. The electronic device according to claim 5, wherein the cloud target number is generated based on the predetermined sampling rate and the number of the points in the point cloud data.

7. The electronic device according to claim 5, wherein the plurality of instructions further cause the processing unit to:
adjust the sampling point cloud when the number of the initial sampling points is not equal to the cloud target number; and
determine the sampling point cloud as a sampling result when the number of the initial sampling points is equal to the cloud target number.

8. The electronic device according to claim 7, wherein the plurality of instructions further cause the processing unit to:
remove a part of the initial sampling points from the sampling point cloud when the number of the initial sampling points is greater than the cloud target number; and
select at least one additional sampling point from the points in the point cloud data and add the at least one additional sampling point into the sampling point cloud when the number of the initial sampling points is less than the cloud target number.

9. A sampling method for sampling point cloud data executed by an electronic device, the method comprising:
receiving the point cloud data;
generating a bounding box for the point cloud data;
dividing the bounding box into a plurality of segmented boxes;
selecting a plurality of data boxes from the plurality of segmented boxes, wherein each of the data boxes includes at least one point in the point cloud data;
assigning a reference value to each of the at least one point in the plurality of data boxes;
selecting at least one initial sampling point from the at least one point in each of the data boxes based on the reference values to form a sampling point cloud; and
adjusting the sampling point cloud based on the number of the initial sampling points and a predetermined sampling rate.

10. The method according to claim 9, comprising:
sorting the at least one point in each of the data boxes based on the reference values to form a sorting list;
determining a box target number for each of the data boxes based on the predetermined sampling rate; and
selecting sequentially the at least one initial sampling point from the sorting lists based on the box target numbers.

11. The method according to claim 10, wherein each of the box target number is generated based on the predetermined sampling rate and the number of the points in each of the data boxes.

12. The method according to claim 10, comprising:
comparing the number of at least one specific point in a specific data box with a specific box target number of the specific data box;
determining the at least one specific point as the at least one initial sampling point when the number of the at least one specific point is equal to or less than the specific box target number;
selecting sequentially the at least one initial sampling point based on the specific box target number when the number of the at least one specific point is greater than the specific box target number.

13. The method according to claim 9, comprising:
determining a cloud target number for the point cloud data based on the predetermined sampling rate;
comparing the number of the initial sampling points to the cloud target number.

14. The method according to claim 13, wherein the cloud target number is generated based on the predetermined sampling rate and the number of the points in the point cloud data.

15. The method according to claim 13, comprising:
adjusting the sampling point cloud when the number of the initial sampling points is not equal to the cloud target number; and
determining the sampling point cloud as a sampling result when the number of the initial sampling points is equal to the cloud target number.

16. The method according to claim 15, comprising:
removing a part of the initial sampling points from the sampling point cloud when the number of the initial sampling points is greater than the cloud target number; and
selecting at least one additional sampling point from the points in the point cloud data and adding the at least one additional sampling point into the sampling point cloud when the number of the initial sampling points is less than the cloud target number.
